(19) United States
(12) Patent Application Publication
(10) Pub. No.: US 2014/0095268 A1
(43) Pub. Date: Apr. 3, 2014

(54) SYSTEM AND METHOD OF IMPROVING CONTACT CENTER SUPERVISOR DECISION MAKING

(71) Applicant: AVAYA INC., Basking Ridge, NJ (US)

(72) Inventors: Neil O'Connor, Galway (IE); Paul D'Arcy, Limerick (IE); Tony McCormack, Galway (IE)

(73) Assignee: Avaya Inc., Basking Ridge, NJ (US)

(21) Appl. No.: 13/630,179

(22) Filed: Sep. 28, 2012

(51) Int. Cl. G06Q 10/06

(52) U.S. Cl. 705/7.39

(57) ABSTRACT

Various embodiments of systems and methods for facilitating decision making in a business operation are described herein. In an embodiment, the method involves receiving a first set of data representing predefined optimal performance factors of the business operation and generating a performance baseline based on an aggregate of the optimal performance factors. Further, the method involves receiving, in real-time, a second set of data representing performance measures initiated by a plurality of entities and predicting a potential business performance based on analyzing a collective impact of the initiated performance measures on a current business performance. In another aspect, the method involves comparing the predicted business performance with the generated performance baseline and providing a recommendation on the initiated performance measures based on the comparison.

### BACKGROUND

1. Field of the Invention

Embodiments of the present invention relate generally to business management systems. More specifically, the present invention relates to a system and method for facilitating decision making to implement performance measures in a business operation.

2. Description of Related Art

Within contact center of enterprises and business process outsourcing (BPO), there is usually one supervisor for multiple agents. The supervisors spend a substantial amount of time monitoring the Key Performance Indicators (KPIs) and other real-time business information, in order to keep the BPO operating within prescribed limits. Some of the main KPIs of the BPO include: quality, customer satisfaction, and average handle time (AHT). BPOs often have clients who expect a certain target KPIs to be met. The target KPIs are defined as a set of values corresponding to quality, customer satisfaction rating, and average handling time for each call that is handled by the BPO. In certain scenarios, the supervisors may be required to implement certain operational changes such as increasing or decreasing the KPIs in order to bring the deviating KPIs back within the prescribed limits. However, increasing one KPI component may affect another KPI negatively or often have unintended side effects on the overall performance of the BPO.

For example, a BPO aiming to increase its customer satisfaction scores for the offered services may affect a significant drop in the average handle time scores for the same offered services. This is because, an agent in an attempting to please the customer and to gain the customer's confidence would entail having to stay longer on each call to make sure that all of the customer's issues are resolved, and in the most courteous way possible. As another consequence, apart from the AHT scores being affected, quality scores may also reduce since the agents might grant certain customer's requests which contradict the quality guidelines set for each service by the client.

Alternatively, if the BPO aims to improve its average handle time scores and takes certain measures to improve it, the customer satisfaction score may be set to decrease. The quality scores may also be affected due to pre-mature closing of the calls in an attempt to constrict the AHTs.

One of the currently used solutions is to maintain an average score for each KPI component so that it will be more controllable to have all the scores meet at the middle and avoid having low scores in some components. Another solution lists out the individual performance indicators and compares the individual performance indicators against pre-defined thresholds. Based in the comparison, a set of corrective measures are proposed. However, none of the existing solutions enable decision making based on considering the interdependencies between the various performance measures initiated or implemented by multiple supervisors.

### SUMMARY

Embodiments in accordance with the present invention relate to systems and methods for facilitating decision making in a business operation. An example of a business operation is the operation of a contact center. In an embodiment, the method involves receiving a first set of data representing predefined optimal performance factors of the business operation. In an aspect, the method involves generating a performance baseline based on an aggregate of the optimal performance factors. Further, the method includes receiving, in real-time, a second set of data representing performance measures initiated by a plurality of entities and predicting a potential business performance based on analyzing a collective impact of the initiated performance measures on a current business performance. In another aspect, the method involves comparing the predicted business performance with the generated performance baseline and providing a recommendation on the initiated performance measures based on the comparison.

In an embodiment, the system for facilitating decision making in a business operation includes a computer comprising a memory to store a program code, and a processor to execute the program code. The processor executes the program code to receive a first set of data representing predefined optimal performance factors of the business operation. In an aspect, the processor executes the program code to generate a performance baseline based on an aggregate of the optimal performance factors. Further, the processor executes the program code to receive, in real-time, a second set of data representing performance measures initiated by a plurality of entities and predict a potential business performance based on analyzing a collective impact of the initiated performance measures on a current business performance. In another aspect, the processor executes the program code to compare the predicted business performance with the generated performance baseline and provide a recommendation on the initiated performance measures based on the comparison.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a flow diagram of a method for facilitating decision making in a business operation, according to one embodiment of the present invention;

FIG. 2 is a flow diagram of a method for facilitating decision making in a business operation, according to another embodiment of the present invention;

FIG. 3 is a block diagram of an exemplary system for facilitating decision making in a business operation, according to one embodiment of the present invention; and

FIG. 4 illustrates a block diagram of an exemplary computer system configured in accordance with an embodiment of the present invention.

The headings used herein are for organizational purposes only and are not meant to be used to limit the scope of the description or the claims. As used throughout this application, the word “may ” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of techniques for facilitating decision making in a business operation in real-time are described herein. An example of a business operation is the operation of a contact center. In the following description, numerous specific details are set forth to provide a thorough understanding of embodiments of the present invention. One skilled in the relevant art will recognize, however, that the present invention can be practiced without one or more of the specific details, or with other methods, components, materials, etc. In other instances, well-known structures, materials, or operations are not shown or described in detail to avoid obscuring aspects of the present invention.

The concept underlying the techniques for facilitating decision making in business operations, relating to businesses such as a BPO industry, lies in predicting the outcome of intended performance measures with a view to potentially dissuading or persuading supervisors from continuing with an action they initiated. The potential outcome of an intended performance measure is predicted by using key performance indicators (KPIs) and the initiated performance measures as inputs for prognostic models. Alternatively, the outcome of the intended performance measure can be predicted using historical data relating to the key performance indicators that are affected by the performance measures.

The term “performance measures” as used herein refers to a maneuver to modify one or more performance factors that directly or indirectly alter the key performance indicators of the business operation. The term “potential outcome” as used herein refers to a foreseen, quantifiable consequence or effect of a certain action. The term “real-time” as used herein refers to a time frame that is brief, appearing to be immediate or near concurrent.

The term “Key Performance Indicators” as used herein refers to performance metrics used for measuring a performance of the business operation. Examples of KPIs include: average talk time (ATT), after call work (ACW), average handling time (AHT), calls per hour, call abandon rate, first call resolution, Customer satisfaction rating (CSat), attrition, etc. KPIs act as indicators and provide information required to make more informed decisions and intelligent choices. KPIs can help us to understand more about an organizations products, processes, and services. KPIs can be used to evaluate an organizations products, processes, and services against established standards and goals. KPIs can provide the information required to control resources and processes used to provide a service or product. KPIs can be used to predict attributes of business entities in the future. KPIs provide measures to judge the efficiency of various business operations.

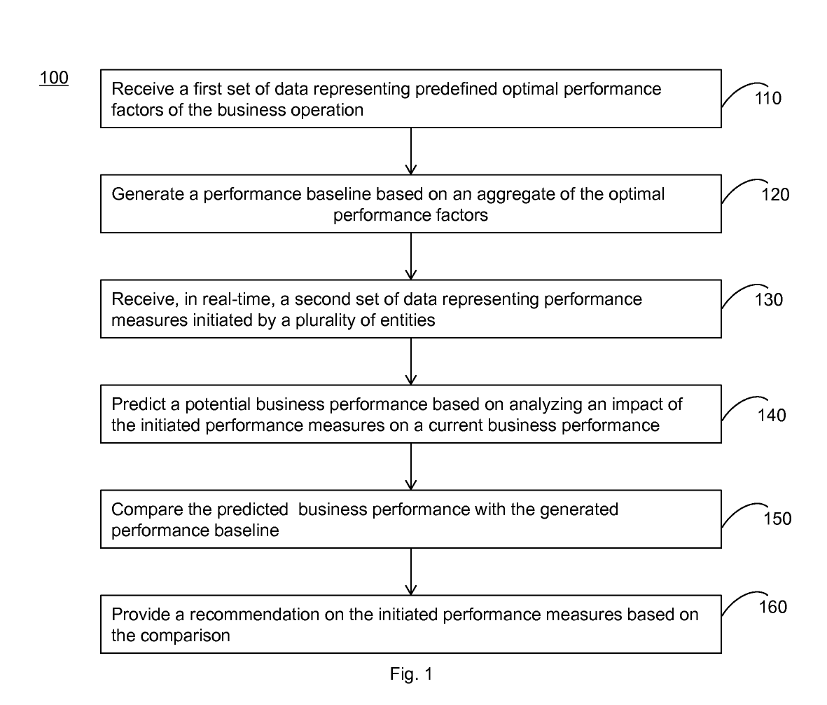

FIG. 1 illustrates a flow diagram of a method 100 for facilitating decision making in a business operation in real-time. The method 100, implemented by a computer or any other electronic device having processing capabilities, includes at least the following process steps illustrated with reference process blocks 110-160. The method 100 involves receiving a first set of data representing predefined optimal performance factors of the business operation, at process block 110. The term “optimal performance factors” as used herein refers to factors that lead to attaining a set of business goals defined by a business plan. The business plan includes a formal statement of the set of business goals, a plan for reaching those goals, and sub-plans covering marketing, finance, operations, human resources. Examples of optimal performance factors include expected rate of increase in operating costs, accounts receivable, rate of increase in revenues, rate of increase in employee's remuneration, number of clients, number of outsourcing activities handled, operations, average team size, number of projects completed in time, accuracy of operations, project related training programs, etc.

Further, the method 100 involves aggregating the optimal performance factors and generating a performance baseline based on the aggregate of the optimal performance factors, at process block 120. In an aspect, aggregating the optimal performance factors involves translating the optimal performance factors into real-time data. For example, an operational performance factor such as an increased revenue is translated into KPIs such as number of agents handling outbound calls, average handling time, mandatory pitch for sale, etc., that drive this particular performance factor. The term “performance baseline” as used herein refers to a set of reference metrics derived from an aggregate of the predefined optimal performance factors.

At process block 130, the method 100 involves receiving, in real-time, a second set of data representing performance measures initiated by a plurality of entities. The term “initiate” as used herein refers to a maneuver to express intent to bring about a certain task, action, or event into being. In an example, a first supervisor may want to increase the number of agents making an outbound call in order to meet the sales target for the day. Whereas, a second supervisor within the same business operation, may want to decrease the average talk time by his agents in order to decrease the average handling time.

At process block 140, a potential performance of the business after being subject to the performance measures is predicted based on analyzing an impact of the initiated performance measures on a current business performance. In an aspect, the potential business performance is predicted by invoking a relationship data of the initiated performance measures. The relationship data may be a pre-defined data accessed from memory or received via a user interface as input. The relationship data defines one or more constraints effecting interdependencies between initiated performance measures. For example, the relationship data may define that for a certain percentage increase in average handle time a certain percentage of dip in customer satisfaction score and first call resolution rate, is expected. Further, the KPIs representing the current business performance is accessed in real-time from a reporting tool and an impact of each of the initiated performance measures on the current key performance indicators is assessed using the one or more constraints defined by the relationship data. The potential business performance is then predicted based on an aggregate of the assessed impact of the performance measures. In the given example, a potential business performance is predicted based on an impact of increasing the number of agents making outbound sales calls by the first supervisor and decreasing the average talk time by the second supervisor on the current key performance indicators.

Further, at process block 150, the predicted business performance is compared with the generated performance baseline, and a recommendation on the initiated performance measures is provided at process block 160. In an aspect, the predicted business performance is compared with the generated performance baseline to determine whether the predicted business performance exceeds or falls below the performance baseline as a result of implementing a corresponding performance measure. Process block 150 may include one or more performance changes in its analysis. For example, within a short period of time, say five seconds, two supervisors in a contact center might enter a configuration change. A system implementing method 100 may assess a joint influence of these changes against the performance baseline, and provides a recommendation at process block 160. For example, one of the configuration changes may result in a recommendation to proceed and one configuration change may not result in a recommendation to proceed. In another example, both configuration changes may result in agreement of analytic results from the system. The system may scale up to many hundreds of intended changes within a short period of each other, while offering an aggregated assessment of the impact of the changes, and issue appropriate recommendations. If assessing an individual performance measure, the system may operate in a similar fashion, but it would have much less work to do. For example, a step of aggregating the impact of multiple intended performance changes would not be required. Therefore in the case of an individual performance measure, the system measures the impact of this change against the baseline and issues a recommendation to that single user. If the predicted business performance exceeds or meets the performance baseline then the corresponding performance measure is approved. On the other hand, if the predicted business performance falls below the performance baseline then the corresponding performance measure is disapproved. In an aspect, the recommendation and/or approval or disapproval of the performance measure is provided in real-time as a prompt or a message on a user interface of the computer implementing the method 100.

In another embodiment, the potential performance of the business after being subject to the initiated performance measures is predicted. The method involves invoking a historical data relating to business operations in the past, wherein the historical data comprises operational metrics relating to one or more performance measures implemented in the past. Further, the initiated performance measures are compared with the performance measures implemented in the past to determine whether one or more of the initiated performance measures match one or more performance measures implemented in the past. If at least one match is found based on the comparison, then the operational metrics corresponding to the matching performance measure(s) implemented in the past are identified. A potential business performance is predicted based on the identified operational metrics.

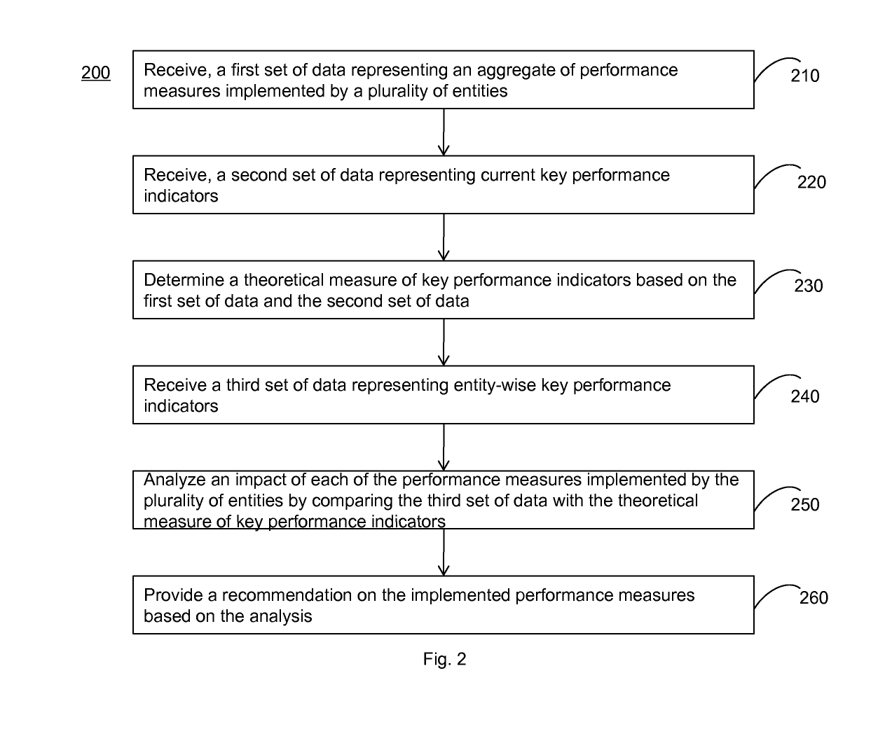

FIG. 2 illustrates a flow diagram of a method 200 for facilitating decision making, according to an embodiment. The method 200, implemented by a computer or any other electronic device having processing capabilities, includes at least the following process steps illustrated with reference process blocks 210-260. The method 200 involves receiving a first set of data representing an aggregate of performance measures implemented by a plurality of entities, at process block 210. At process block 220, a second set of data is received, where the second set of data represents current key performance indicators. In an aspect, the current key performance indicators represent a current business operation that is subject to the implemented performance measures. At process block 230, based on the first set of data and the second set of data, a theoretical measure of key performance indicators is determined. The theoretical measure of the key performance indicators represents an overall measure of the business performance that would have ensues if the performance measures were not implemented.

At process block 240, a third set of data representing entity-wise key performance indicators is received. An impact of each of the implemented performance measures is analyzed by comparing the third set of data with the theoretical measure of key performance indicators, at process block 250. Further at process block 260, a recommendation on the initiated performance measures is provided based on the analysis. In an aspect, the recommendation includes a report on the underlying impact of the implemented performance measures, individually, on the overall business performance. Such reporting information can be used to demonstrate entities such as supervisors how their future decision making can be improved for a similar business operation conditions.

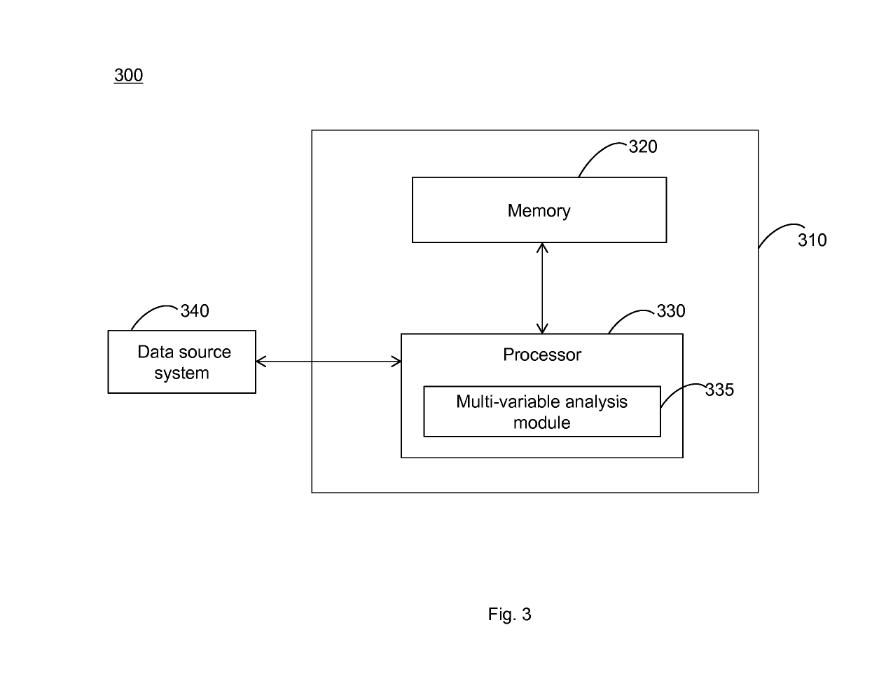

FIG. 3 is a block diagram of an exemplary system for automatically measuring and tracking the quality of product modules, according to one embodiment. The system 300 is communicatively coupled to a data source system 310. The data source system 310 refers to sources of data that enable data storage and/or retrieval. In an embodiment, the system 300 includes a computer 320 having a processor 330 and memory 340. The processor 330 executes software instructions or code, for facilitating decision making in a business operation, stored on a computer readable storage medium such as the memory 340, to perform the above-illustrated methods. The system 300 includes a media reader to read the instructions from the computer readable storage medium 340 and store the instructions in storage or in random access memory (RAM). For example, the computer readable storage medium 340 includes executable instructions for performing operations including, but not limited to, receiving a first set of data representing predefined optimal performance factors of the business operation; generating a performance baseline based on an aggregate of the optimal performance factors; receiving, in real-time, a second set of data representing performance measures initiated by a plurality of entities; predicting a potential business performance based on analyzing a collective impact of the initiated performance measures on a current business performance by the multi-variable analysis module 335; comparing the predicted business performance with the generated performance baseline; and providing a recommendation on the initiated performance measures based on the comparison.

In an aspect, the executable instructions for performing the steps of the methods 100 and 200 are embodied as a decision making tool. The decision making tool may be implemented as a component within the processor 330 or as a separate component external to the processor 330. Based on the instructions, the decision making tool integrates information relating to key performance indicators and performance measures from various systems associated with the multiple entities. The information is then stored in memory 320 or within a data repository 340. The key performance indicators integrated by the decision making tool, is associated with individual entities such as a team, process, program, or shift and represent a current business performance. Further, based on the instructions in the memory 320, the decision making tool generates a performance baseline based on aggregating a pre-defined set of optimal performance factors from memory 320. Further, based on the instructions, the decision making tool detects performance measures initiated by the plurality of entities. In an aspect, a technology such as a clickstream technology is used to harvest the actions of a supervisor on a user interface to initiate a performance measure. In an example, the clickstream technology is used to detect whenever a certain performance measure is selected or opted for by means of inputs provided via the user interface.

Further, the decision making tool predicts a potential business performance based on analyzing an impact of the initiated performance measures on a current business performance. The decision making tool then compares the predicted business performance with the generated performance baseline to provide recommendations on the initiated performance measures.

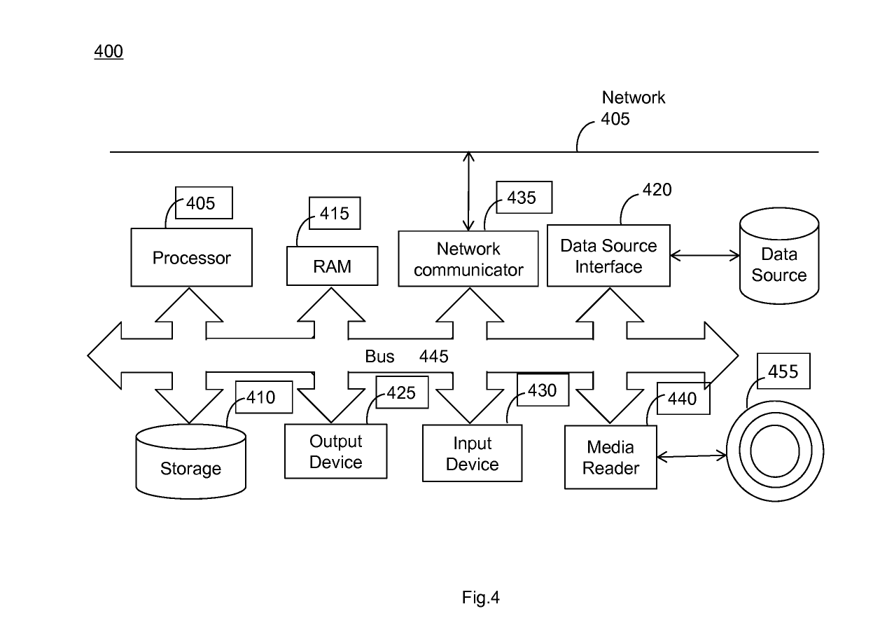

FIG. 4 is a block diagram of an exemplary computer system 400. The computer system 400 includes a processor 405 that executes software instructions or code stored on a computer readable storage medium 455 to perform the above-illustrated methods of the present invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the present invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the foregoing specification, specific embodiments have been described. However, one of ordinary skill in the art appreciates that various modifications and changes can be made without departing from the scope of the present invention as set forth in the claims below. For example, the order of the signaling within each flow diagram does not necessarily denote order and timing of the signaling unless specifically indicated.

Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

What is claimed is:

1. A computer-implemented method for facilitating decision making in a business operation, the method comprising:
receiving a first set of data representing predefined optimal performance factors of the business operation;
generating a performance baseline based on an aggregate of the optimal performance factors;
receiving, in real-time, a second set of data representing performance measures initiated by a plurality of entities;
predicting a potential business performance based on analyzing an impact of the initiated performance measures on a current business performance;
comparing the predicted business performance with the generated performance baseline; and
providing a recommendation on the initiated performance measures based on the comparison.

2. The method of claim 1, wherein predicting the potential business performance comprises:
invoking relationship data of the initiated performance measures, wherein the relationship data defines one or more constraints effecting interdependencies between the initiated performance measures;
accessing current key performance indicators representing the current business performance; and
predicting the potential business performance based on assessing a collective impact of the initiated performance measures on the current key performance indicators, using the one or more constraints.

3. The method of claim 1, wherein predicting the potential business performance comprises:
invoking historical data relating to business operations, wherein the historical data comprises operational metrics relating to one or more performance measures implemented in the past;
comparing the initiated performance measures with the performance measures implemented in the past;
upon determining that one or more of the initiated performance measures match one or more performance measures implemented in the past, identifying the operational metric(s) corresponding to the one or more performance measures implemented in the past; and
predicting the potential business performance based on the identified operational metrics.

4. The method of claim 3, wherein the operational metrics relating to the one or more performance measures implemented in the past comprises a quantitative measure of the key performance indicators resulting from implementing the performance measures in the past.

5. The method of claim 1, wherein comparing the predicted business performance with the generated performance baseline comprises determining whether the predicted business performance exceeds or falls below the performance baseline.

6. The method of claim 1, wherein the business operation comprises operation of a contact center.

7. The method of claim 1, wherein providing a recommendation on the initiated performance measures comprises approving at least one of the performance measures if the predicted business performance exceeds or meets the performance baseline.

8. The method of claim 1, wherein providing a recommendation on the initiated performance measures comprises disapproving at least one of the performance measures if the predicted business performance falls below the performance baseline.

9. The method of claim 1, wherein the initiated performance measures include adopting employee skills, modifying contact types, adapting call related metrics, and enhancing employee skills.

10. The method of claim 1, wherein the optimal performance factors include pre-planned metrics for factors such as quality, customer satisfaction, average call handling time, first resolution, abandoned calls, dropped calls, call waiting, and employee attrition.

11. An article of manufacture, comprising:
a non-transitory computer readable storage medium having instructions which when executed by a computer causes the computer to:
receive, a first set of data representing an aggregate of performance measures implemented by a plurality of entities;
receive, a second set of data representing current key performance indicators, wherein the current key performance indicators represent a current business operation that is subject to the implemented performance measures;
determine a theoretical measure of key performance indicators based on the first set of data and the second set of data, wherein the theoretical measure of key performance indicators represents an overall measure of business performance that would have ensued if the performance measures were not implemented;
receive a third set of data representing entity-wise key performance indicators;
analyze an impact of each of the performance measures implemented by the plurality of entities by comparing the third set of data with the theoretical measure of key performance indicators; and
provide a recommendation on the implemented performance measures based on the analysis.

12. The article of manufacture in claim 11, wherein provide a recommendation on the initiated performance measures based on the analysis comprises reporting an underlying impact of the implemented individual performance measures on the overall business performance.

13. The article of manufacture in claim 11, wherein the plurality of entities includes supervisors, managers, or any other personnel involved in making business decisions.

14. The article of manufacture in claim 11, wherein the performance measures initiated by the plurality of entities relate to actions that directly or indirectly alter the current key performance indicators and thereby impact the business operation.

15. A system comprising:
a computer comprising a memory to store a program code, and a processor to execute the program code to:
receive a first set of data representing predefined optimal performance factors of the business operation;
generate a performance baseline based on an aggregate of the optimal performance factors;
receive, in real-time, a second set of data representing performance measures initiated by a plurality of entities;
predict a potential business performance based on analyzing an impact of the initiated performance measures on a current business performance;
compare the predicted business performance with the generated performance baseline; and
provide a recommendation on the initiated performance measures based on the comparison.

16. The system of claim 15, wherein the performance baseline comprises a set of reference metrics derived based on an aggregate of the predefined optimal performance factors.

17. The system of claim 15, wherein the performance measures initiated by the plurality of entities relate to actions that directly or indirectly alter the current key performance indicators and thereby impact the business operation.

18. The system of claim 15, wherein the initiated performance measures include adopting employee skills, modifying contact types, adapting call related metrics, and enhancing employee skills.

19. The system of claim 15, wherein the optimal performance factors include pre-planned metrics for factors such as quality, customer satisfaction, average call handling time, first resolution, abandoned calls, dropped calls, call waiting, and employee attrition.

20. The system in claim 15, wherein provide a recommendation on the initiated performance measures comprises disapproving at least one of the performance measures if the predicted business performance falls below the performance baseline.

21. The system in claim 15, wherein provide a recommendation on the initiated performance measures comprises approving at least one of the performance measures if the predicted business performance exceeds or meets the performance baseline.
